(19) United States
(12) Patent Application Publication
(10) Pub. No.: US 2019/0176986 A1
(43) Pub. Date: Jun. 13, 2019

(54) MULTI-CRAFT UAV CARRIER SYSTEM AND AIRFRAME

(71) Applicant: Stealth Air Corp, Shirley, NY (US)

(72) Inventors: Nicholas Addonisio, Eastport, NY (US); Ezra Green, Massapequa, NY (US)

(21) Appl. No.: 16/323,173

(22) PCT Filed: Aug. 1, 2017
(86) PCT No.: PCT/US2017/044797

§ 371 Date: Feb. 4, 2019

Related U.S. Application Data
(60) Provisional application No. 62/370,373, filed on Aug. 3, 2016.

(51) Int. Cl. B64C 39/02; G05D 1/10; G05D 1/00

(52) U.S. Cl. CPC B64C 39/024; G05D 1/104; G05D 1/0027; B64C 2201/206; B64C 2201/082; B64C 2201/141; B64C 2201/146; B64C 2201/027

(57) ABSTRACT

Disclosed is a system (100) for a multi-craft unmanned aerial vehicle (UAV) carrier system, including a carrier UAV (101), including an upper surface (105), a control system (201), and a transceiver for conducting communications with a remote location, and a plurality of drone UAVs (102) attachable to and launchable from the upper surface (105) of the carrier UAV (101), each of the plurality of drone UAVs (102) including a drone control system (107) and a transceiver for conducting communications with a remote location.

### REFERENCE TO PRIOR APPLICATION

This application claims the benefit of U.S. Provisional Application No. 62/370,373, filed Aug. 3, 2016, the entire contents of which are incorporated herein by reference.

### TECHNICAL FIELD

The present invention relates to unmanned aerial vehicles (UAVs), and more particularly to systems and methods for transporting one or more compact aerial vehicles via a carrier drone.

### BACKGROUND

Currently, unmanned aerial vehicles are single systems that fly to and from their intended targets. Weight and fuel restrictions typically define the flight paths of the UAV. Flying individual UAVs to a similar location wastes valuable fuel and equipment.

Additionally, an occurrence where multiple threats or events are detected often require more aerial surveillance and monitoring than a single UAV can provide.

What is needed to solve these problems in the prior art is a system which provides for the transport of multiple UAVs to conserve fuel and resources while offering mixed airframe characteristics advantages.

### SUMMARY

The intended use of the technology is to provide systems and methods for transporting a plurality of unmanned aerial vehicle drones via an unmanned aerial vehicle carrier.

According to a first aspect of the disclosure, provided is a system for a multi-craft unmanned aerial vehicle (UAV) carrier system, comprising: a carrier UAV, comprising: an upper surface, a control system, and a transceiver for conducting communications with a remote location, and a plurality of drone UAVs attachable to and launchable from the upper surface of the carrier UAV, each of the plurality of drone UAVs comprising: a drone control system, and a transceiver for conducting communications with a remote location.

According to a second aspect of the disclosure, provided is a system for a multi-craft unmanned aerial vehicle (UAV) carrier airframe, comprising: a plurality of motor arms projection radially outward from a central axis of the carrier frame, each motor arm configured to receive a motor at a distal end thereof, and a drone platform positioned at or above a plane of the plurality of motor arms, said carrier platform configured to receive at least one independent and separable drone UAV and provide a launch platform therefrom.

According to a third aspect of the disclosure, provided is a system for a multi-craft unmanned aerial vehicle (UAV) carrier system, comprising: a carrier UAV, comprising: a control system, and a transceiver for conducting communications with a remote location, one or more drone UAVs attachable to and launchable from the carrier UAV, each of the plurality of drone UAVs comprising: a drone control system, and a transceiver for conducting communications with a remote location.

### BRIEF DESCRIPTION OF THE DRAWINGS

The present disclosure will become more readily apparent from the specific description accompanied by the drawings.

FIG. 1 is a top plan view of a multi-craft UAV carrier system according to the present disclosure.

FIG. 2 is a perspective view of a multi-craft UAV carrier system according to the present disclosure.

FIG. 3 is perspective view of an airframe for a carrier UAV of a multi-craft UAV carrier system according to the present disclosure.

FIG. 4 is a diagram of a multi-craft UAV carrier system according to the present disclosure.

FIG. 5 is an illustration of a camera image from a carrier UAV of a multi-craft UAV carrier system according to the present disclosure.

FIG. 6 is an illustration of a camera image from a first drone UAV of a multi-craft UAV carrier system according to the present disclosure.

FIG. 7 is an illustration of a camera image from a second drone UAV of a multi-craft UAV carrier system according to the present disclosure.

FIG. 8 is an illustration of a camera image from a third drone UAV of a multi-craft UAV carrier system according to the present disclosure.

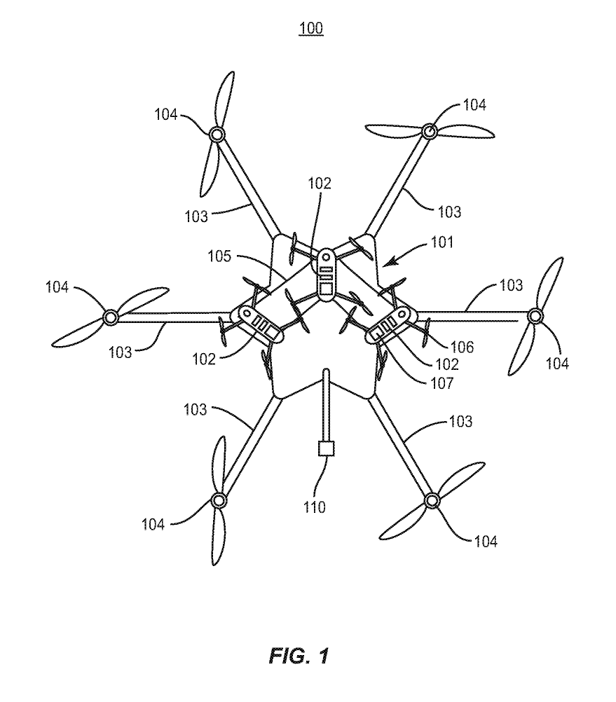

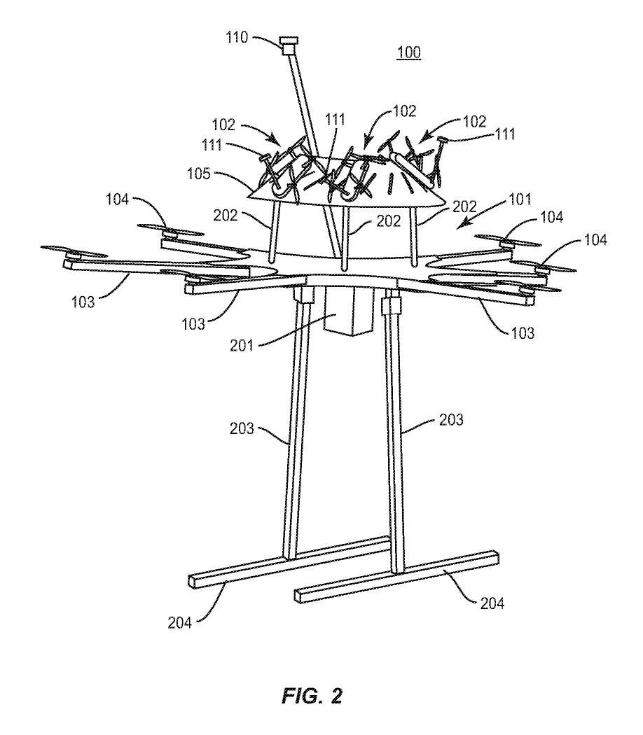

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

Reference will now be made in detail to the exemplary embodiments of the present disclosure, which are illustrated in the accompanying figures.

A multi-craft UAV carrier system 100 is disclosed herein. Multi-craft UAV carrier system 100 is comprised of a carrier UAV 101 and one or more drone UAVs 102.

Carrier UAV 101 consists of one large (relative to the size of drone UAVs 102), utility, aerial vehicle that acts as a mobile aerial platform, which has the payload capacity equal to or greater than the drone UAVs 102 which are carried. Carrier UAV 101 includes an airframe 300 having a plurality of motor arms 103 extending radially outward from a central axis. Positioned at a distal end of each motor arm 103 is a motor/propeller assembly 104. Positioned on an upper surface of airframe 300 of carrier UAV 101 is a drone platform 105. Drone platform 105 is configured to receive one or more drone UAVs 102 and provide a launch platform for drone UAVs 102. The positioning of the drone platform 105 elevates drone UAVs 102 above the plane of the propellers on carrier UAV 101 to reduce the effect of carrier UAV 101 propeller wash. Carrier UAV 101 also includes a control system 201 to provide operation control for carrier UAV 101. Control system 201 can include a processor, memory, an autopilot, inputs (e.g., on/off switches, microphones, etc.), outputs (e.g., speakers, lights, LEDs, etc.), and a transceiver for conducting communications (control commands, data transfer, etc.) with an operator. The system might also include a wireless receiver and transmitter system that operates using any wireless technology including radio frequency, Wi-Fi, Bluetooth, ZigBee, satellite, or cellular communication. The wireless communication equipment can serve the purpose of remotely commanding flight functions of the carrier UAV in addition to the hold or release of onboard drone UAVs. The system might also include an onboard computer which acts independently or in coordination with the flight controller for flight, drone UAV deployment or advanced auxiliary component commands.

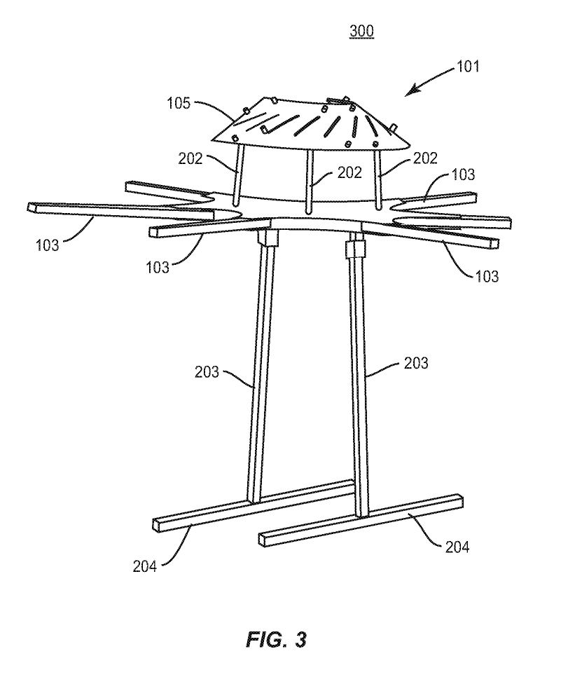

A basic airframe 300 of carrier UAV 101 is illustrated in FIG. 3, and includes the plurality of motor arms 103 and drone platform 105. Drone platform 105 is raised above motor arms 103 via elevation masts 202. The length of elevation masts 202 can vary, but are designed to raise drone platform 105 above motor/propeller assemblies 104. Airframe 300 can include landing assemblies that include stanchions 203 and skids 204.

A surface of drone platform 105 is preferably positioned at an angle relative to a planar surface of motor arms 103. This angle can be from a position parallel to airframe 300 or up to ninety degrees perpendicular to airframe 300, and is preferably at an angle of 20 degrees or less. This angle provides a good launch platform for drone UAVs 102. There are many benefits to an angled drone platform 105. First, during deployment or take-off, drone UAVs 102 are forced to fly away from carrier UAV 101 which prevents collision with critical components, such as navigation and flight controller equipment, on carrier UAV 101. Second, an angled drone platform 105 provides a more efficient way to “stagger” drone UAVs 102 to reduce the overall form factor of drone platform 105. Third, the angled platform creates a greater distance between flight control components of carrier UAV 101 and motors 106 of drone UAVs 102 which helps prevent electro-magnetic interference caused by motors 106 which could adversely affect flight performance of carrier UAV 101.

In certain embodiments, one or more drone platforms 105 can be positioned at one or more locations to transport drone UAVs 102 on the top of carrier UAV 101, on the bottom of carrier UAV 101, and/or inside carrier UAV 101.

Generally, drone UAVs 102 are compact aerial vehicles that are designed for performance or basic utility such as carrying a camera for filming purposes. These compact aerial vehicles may be of any frame configuration, for example, multi-rotors (e.g., tricopter, quadcopter, hexacopter, octocopter, octoquad), fixed wing aircraft, VTOL aircraft (hybrid fixed wing design with vertical lift/take-off capability), or rotary (e.g., helicopter).

Typical Drone UAVs 105 include motor/propeller assemblies 106, peripherals 111, and a control system 107 to provide operation control for drone UAV 102. Control system 107 can include a processor, memory, an autopilot, inputs (e.g., on/off switches, microphones, etc.), outputs (e.g., speakers, lights, LEDs, etc.), and a transceiver for conducting communications (control commands, data transfer, etc.) with an operator.

Each of the carrier UAV 101 and drone UAVs 102 can also include one or more related peripheral 110/111 respectively. For example, as shown in drawings, carrier UAV is shown equipped with a camera 110 and each drone UAV 102 is shown equipped with a camera 111. Other peripherals are contemplated, including infrared cameras, night vision cameras, audio devices, speakers, microphones, radar, equipment supplies for delivery, onboard processing computers, payload release hardware, wireless repeaters, etc.

Drone UAVs 102 can be carried via carrier UAV 101 via various configurations. These configurations can include un-constrained and/or affixed by semi-permanent means (e.g., adhesive, Velcro®, Velcro®-like tape, electro-permanent magnet, rope, servo system or similar). Drone UAVs 102 can be carried in varying orientations and even stacked on top of each other for spatial considerations.

Carrier UAV 101 can include a cargo vehicle storage bay, a docking and release area, non-slip or non-skid surfaces (to prevent movement of drone UAVs 102), relatively frictionless surfaces to promote drone UAVs 102 dispatch, an anti-vibration plane or housing to improve the sensor and vehicle stability of drone UAVs 102 during pre-flight and take-off operations.

Elevation masts 202 (such as a pole or rod) can be included to allow for a housing or drone platform 105 to be separated from the central housing of carrier UAV 101 thus affecting the performance from propeller slipstream and stability of carrier UAV 101.

Drone platform 105 can include a system which enables the launch, catapult or forceful discharge of onboard drone UAVs 102 (including but not limited to a compressed gas, hydraulic, magnets, and spring based systems), a “guide” system such as a rail or pole system which forces drone UAV take-off to occur in a specific and desired direction relative to carrier UAV 101 airframe 300, and/or propeller or propulsion system guards which protect drone UAVs 102 from collision during storage and/or transport and take-off operations.

Drone platform 105 can also include a system which is comprised of a multi-level housing which can rotate (e.g., three “decks” of housing levels which rotate or carousel for combating on-board spatial restrictions), a system to re-charge and/or refuel or swap power sources from drone UAVs 102, and/or a system to allow for swapping of drone UAV payload (e.g., battery, sensors, communication equipment, etc.)

Carrier UAV 101 can include a system to re-charge its own power source (e.g., solar panel(s), wind turbine, etc.). Still further, carrier UAV 101 can include a system that enables carrier UAV 101 to act as a repeater for extended distance wireless communication to one or more drone UAVs 102 (which might include audio, video, telemetry, vehicle diagnostic data, or any data collected while in flight), a system that enables carrier UAV 101 to act as an independent broadcaster or receiver of wireless signal or data (which might include audio, video, telemetry, vehicle diagnostic data, or any environmental data collected while in flight), and/or a system that enables carrier UAV 101 to have the capability of downloading and hosting/storing data collected or transmitted from the compact UAV(s).

Carrier UAV 101 peripheral(s) can include a camera or imaging system which allows for recording and/or viewing of the drone UAV 102 storage and/or take-off areas which can also be used for first-person view (FPV) flight operations, and/or a specialized imaging system for the purpose of uniquely identifying drone UAV 102 pre and post take-off (such as UV or Infrared imagers and lens filters for the purpose of improved identification of compact UAVs with such UV or Infrared emitting light sources).

Generally, drone UAVs 102 are built for short-range, possibly high-speed operation. In the case of first-person-view (FPV) multi-rotor aircraft, a drone UAV 102 might be smaller than 250 millimeters from motor center to motor center (diagonally). These smaller vehicles are designed for use in competitive racing or leisurely activities, for example, a small FPV racing drone such as the ImmersionRC Vortex 250 or the Lumenier QAV 250.

Smaller aircraft for use as drone UAVs 102 are typically designed to carry their power source (such as a battery), transmitting equipment (if equipped), and other auxiliary accessories and peripherals. Such small aircraft, regardless of frame configuration, are generally not used for utility purposes due to thrust and payload restrictions. For example, Tiger Motor Brushless Motors U7 490 KV and MN2214 920 KV could be used on drone UAVs 102. Tiger Motor U7 utility motor is capable of 4620 grams of thrust versus the MN2214 motor which has a maximum tested capability of exerting 952 grams of thrust. These motors would be selected for an airframe 300 design for two very different purposes, one most likely being that of a utility design and one being that of a smaller recreational design.

The multi-craft carrier UAV system maximizes the total thrust performance of a utility motor by considering the total carrier UAV 101 weight and adding the weight of the drone UAVs 102 to fulfill the payload envelope allowed by the manufacturer's motor specifications. Regardless of configuration type (fixed wing, multi-rotor, rotor, or VTOL aircraft), the payload would not only consist of fuel/power source and auxiliary accessories but also any drone UAVs 102 that are being carried or transported.

After one or more drone UAVs 102 have departed from carrier UAV 101, they may be autonomous or controlled by an operator. If controlled by an operator, short-range or long-range telemetry, vehicle control signals, audio/video data, or other flight data may be sent from a transmitter or control station. In the event that signal cannot be broadcasted using conventional methods due to geography, technological limitations or environmental characteristics, carrier UAV 101 might act as a repeater station for extending the range of control signal being broadcasted or received by drone UAV(s) 102.

Carrier UAV 101 and drone UAVs 102 may be controlled by any number of known system, for example, relatively short-range transmitter (such as radio frequency, ZigBee, WLAN, or other similar short-range communication technology), relatively long-range wireless connection (such as satellite, cellular, laser, or other relatively long-range communication technology), and/or pre-programmed autopilot missions whereby the operator may or may not choose to exercise control of the aircraft.

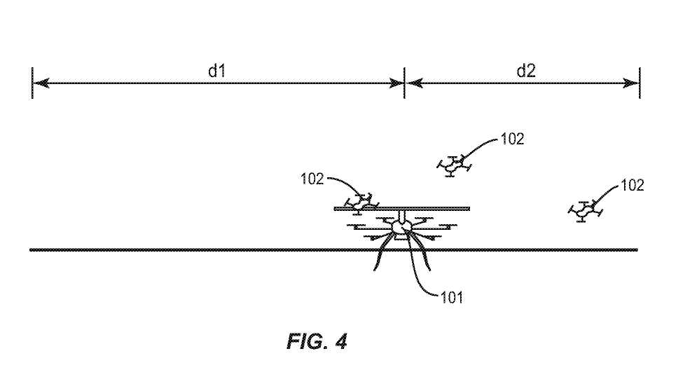

FIG. 4 illustrates some of the benefits of a multi-craft UAV carrier system. Carrier UAV 101 with the capacity to carry several drone UAVs 102 might serve the purpose of lifting or transporting the smaller, more aerodynamic drone UAVs 102 to an environment that can tolerate the high speed agile flight characteristics of drone UAVs 102.

Drone UAVs 102 generally do not have the capacity of long-range flight due to their inability to carry a large payload or fuel source. In the case of multi-rotor aircraft, carrier UAV 101 designed for such a payload might carry one or more drone UAVs 102 to a distance that drone UAVs 102 would not have otherwise been able to achieve on their own. Either mid-air or after landing, drone UAVs 102 could demonstrate aerodynamic flight performance that the larger carrier vehicle might not be able to perform. Upon reaching the location by which drone UAVs 102 would take-off, drone UAVs 102 could now perform high speed or specialized flight requirements.

In the example illustration shown in FIG. 4, carrier UAV 101 might travel a distance d1 (e.g., 8 miles) at a certain rate (e.g., 40 miles per hour). Drone UAVs 102 may then travel a distance d2 (e.g., 2 miles) at a higher rate (e.g., 90 miles per hour). Both carrier UAV 101 and drone UAVs 102 can be flown autonomously by way of a pre-programmed mission or manually by an operator flying using a short-range communication system (e.g., radio frequency, WLAN, etc.) or a longer-range communication system (e.g., cellular, long-range radio, satellite, etc.).

An example of a multi-craft UAV carrier system according to the present disclosure will now be illustrated.

A drone UAV 102, measuring 200 millimeters from motor center to motor center, weighs a total of 3 lbs. A carrier UAV 101, configured as a hexacopter, weighs 40 lbs. including battery payload. The combined take-off weight of carrier UAV 101 (40 lbs.) plus three drone UAVs 102 (3×3 lbs.=9 lbs.) is 49 lbs. The formula to determine required thrust commonly used in the UAV design industry is as follows:

required thrust of each motor=(total weight×2)/number of propellers.

In this example: the required thrust of each motor is:

(49×2)/6=16 lbs.

16 lbs. is the required thrust capability for safe operation of each motor. One type of motor that would satisfy these requirements in the example is a KDE Direct branded brushless motor (Part number: KDE8218XF-120) that is capable of generating 34 lbs. of lift per motor using a 14 cell lithium-polymer battery and a 27.5 inch propeller. This thrust capability is greater than the calculated life requirement for the example above so this selection of propeller, battery and motor would be a feasible design for such an application. In fact, withdrawing safety factors and good practice design measures, this calculation indicates that given the total thrust capability of this example equipment that this carrier UAV 101 could carry up to 54 drone UAVs 102. With the flight efficiency and performance metrics of the utility hexacopter aside, the 54 drone UAVs 102 carrying capacity of carrier UAV 101 can be illustrated as such:

(34 lbs. of lift per motor)×(6 motors)=204 lbs. of thrust (204 lbs. of thrust capability)−(40 lb. carrier UAV weight)=164 lbs. payload envelope (164 lbs. payload capacity)/(3 lbs. per drone UAV)=54.6 drone UAVs.

Other applications for the multi-craft UAV carrier system are contemplated. These other uses can include military and surveillance applications. The payloads the smaller drones can carry can be varied per their application.

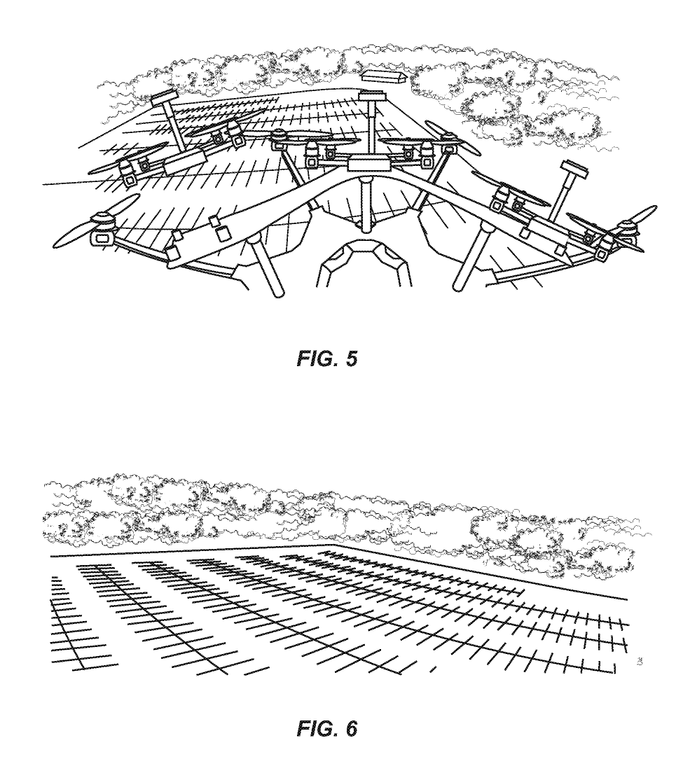

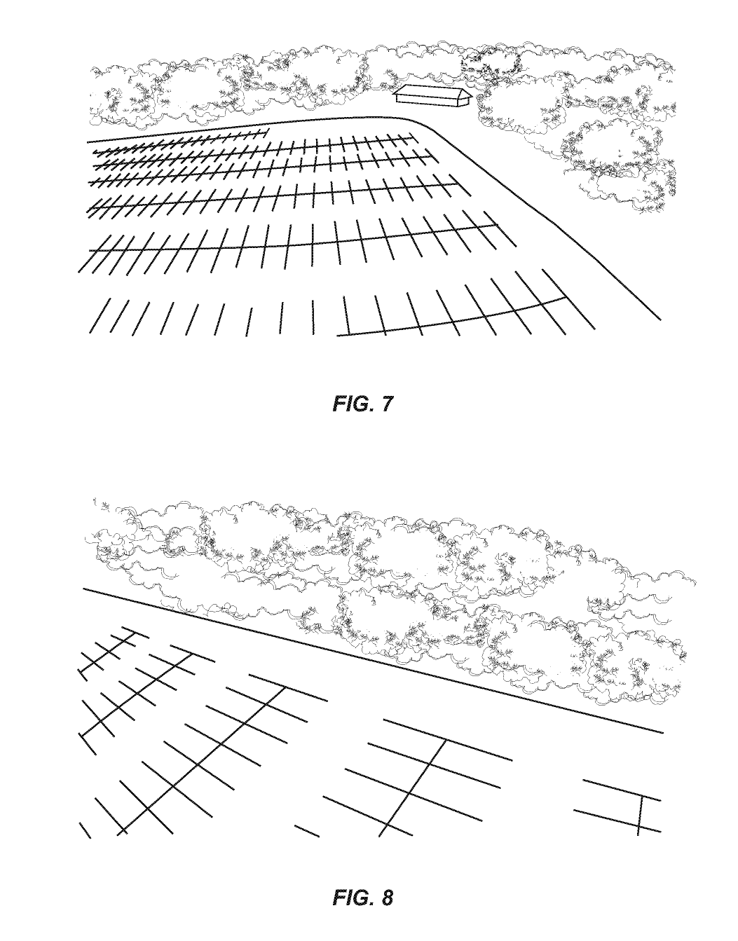

FIGS. 5-8 illustrate camera images from carrier UAV 101 and 3 drone UAVs 102, respectively. In this configuration, each of carrier UAV 101 and drone UAVs 102 include a camera peripheral. The 4 images and/or video are captured from the 4 vehicles at the same time.

Upon the launch of a drone UAV 102 from drone platform 105, drone UAV 102 preferably enters a hover mode to permit a remote pilot to take control of drone UAV 102 or immediately begins an autonomous mission whereby the remote operator can choose to take over flight controls manually or with assistance from the flight controller and onboard navigation equipment. The remote operator of drone UAV 102 may choose to manually (without the assistance of the flight controller or autonomous navigation equipment) deploy from carrier UAV 101 for the purpose of immediate transit to a point of interest. One benefit would be on demand control of drone UAV 102 with instantaneous control of the vantage point of any onboard viewing, recording or data capture equipment.

The multi-craft UAV carrier system and airframe provides systems and methods for transporting a plurality of unmanned aerial vehicle drones via an unmanned aerial vehicle carrier.

Where this application has listed the steps of a method or procedure in a specific order, it may be possible, or even expedient in certain circumstances, to change the order in which some steps are performed, and it is intended that the particular steps of the method or procedure claim set forth here below not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A multi-craft unmanned aerial vehicle (UAV) carrier system, comprising:
a carrier UAV, comprising:
an upper surface;
a control system; and
a carrier transceiver for conducting communications with a remote location; and
a plurality of drone UAVs attachable to and launchable from the upper surface of the carrier UAV, each of the plurality of drone UAVs comprising:
a drone control system; and
a drone transceiver for conducting communications with a remote location.

2. The multi-craft unmanned aerial vehicle (UAV) carrier system according to claim 1, wherein the carrier UAV further comprises an autopilot module for providing a preprogrammed flight pattern for the carrier UAV.

3. The multi-craft unmanned aerial vehicle (UAV) carrier system according to claim 1, wherein the carrier transceiver provides communications for control operations via a remote pilot, and transferring data from the carrier UAV to a remote location.

4. The multi-craft unmanned aerial vehicle (UAV) carrier system according to claim 3, wherein the data includes one or more of camera data, audio data, a preprogrammed flight pattern data.

5. The multi-craft unmanned aerial vehicle (UAV) carrier system according to claim 1, wherein the carrier transceiver operates on one or more of radio frequency, ZigBee, WLAN, satellite, cellular, and laser.

6. The multi-craft unmanned aerial vehicle (UAV) carrier system according to claim 1, wherein the drone UAV further comprises an autopilot module for providing a preprogrammed flight pattern for the drone UAV.

7. The multi-craft unmanned aerial vehicle (UAV) carrier system according to claim 1, wherein the drone transceiver provides communications for control operations via a remote pilot, and transferring data from the drone UAV to a remote location.

8. The multi-craft unmanned aerial vehicle (UAV) carrier system according to claim 7, wherein the data includes one or more of camera data, audio data, a preprogrammed flight pattern data.

9. The multi-craft unmanned aerial vehicle (UAV) carrier system according to claim 1, wherein the drone transceiver operates on one or more of radio frequency, ZigBee, WLAN, satellite, cellular, and laser.

10. The multi-craft unmanned aerial vehicle (UAV) carrier system according to claim 1, wherein the drone enters a hover mode upon launch until remote pilot communications is established.

11. A multi-craft unmanned aerial vehicle (UAV) carrier airframe, comprising:
a body having a plurality of motor arms projecting radially outward from a central axis of the carrier frame, each motor arm configured to receive a motor at a distal end thereof, the plurality of motor arms defining a motor arm plane; and
a drone platform positioned at or above a plane of the plurality of motor arms, said drone platform configured to receive at least one independent and separable drone UAV and provide a launch platform therefor.

12. The multi-craft unmanned aerial vehicle (UAV) carrier airframe of claim 1, further comprising elevation masts positioned between the body and the drone platform.

13. The multi-craft unmanned aerial vehicle (UAV) carrier airframe of claim 1, wherein the drone platform is positioned at an angle from 0 degrees to 90 degrees relative to the motor arm plane.

14. The multi-craft unmanned aerial vehicle (UAV) carrier airframe of claim 1, wherein the drone platform is positioned at an angle from 10 degrees to 30 degrees relative to the motor arm plane.

15. The multi-craft unmanned aerial vehicle (UAV) carrier airframe of claim 1, further comprising:
at least one stanchion connected to an underside of the body at a first end; and
at least one skid connected to a second end of the stanchion.

16. A multi-craft unmanned aerial vehicle (UAV) carrier system, comprising:
a carrier UAV, comprising:
a control system; and
a carrier transceiver for conducting communications with a remote location; and
one or more drone UAVs attachable to and launchable from the carrier UAV, each of the plurality of drone UAVs comprising:
a drone control system; and
a drone transceiver for conducting communications with a remote location.

17. The multi-craft unmanned aerial vehicle (UAV) carrier system according to claim 16, wherein the carrier UAV and drone UAV further comprise an autopilot module for providing a preprogrammed flight pattern.

18. The multi-craft unmanned aerial vehicle (UAV) carrier system according to claim 16, wherein the carrier transceiver operates on one or more of radio frequency, ZigBee, WLAN, satellite, cellular, and laser, and wherein the drone transceiver operates on one or more of radio frequency, ZigBee, WLAN, satellite, cellular, and laser.

19. The multi-craft unmanned aerial vehicle (UAV) carrier system according to claim 1, wherein the carrier transceiver provides communications for control operations via a remote pilot, and transferring data from the carrier UAV to a remote location, and wherein the drone transceiver provides communications for control operations via a remote pilot, and transferring data from the drone UAV to a remote location.

20. The multi-craft unmanned aerial vehicle (UAV) carrier system according to claim 1, wherein the drone enters a hover mode upon launch until remote pilot communications is established.
